(19) United States
(12) Patent Application Publication
(10) Pub. No.: US 2013/0057396 A1
(43) Pub. Date: Mar. 7, 2013

(54) Enhanced Vehicle Security System

(71) Applicant: Randall Winslow, New Orleans, LA (US)

(72) Inventor: Randall Winslow, New Orleans, LA (US)

(21) Appl. No.: 13/226,576

(22) Filed: Sep. 7, 2011

(51) Int. Cl. B60R 25/10

(52) U.S. Cl. 340/426.19

(57) ABSTRACT

An enhanced vehicle security system comprising a camera mounted within a cabin of a vehicle, where upon activation the camera begins recording; a GPS tracker equipped within the vehicle, where upon activation the GPS tracker monitors a global positioning of the vehicle; an alarm within the vehicle, where the alarm is triggered when the vehicle is tampered with, and where when the alarm is triggered the camera and the GPS tracker are activated; a signal sent from the alarm when the alarm is triggered; and a handheld device transported with a user, where the handheld device receives the signal from the alarm.

### BACKGROUND OF THE INVENTION

1. Field of the Invention

The present invention relates to an enhanced vehicle security system that mounts inside the vehicle cabin to prevent theft or damage to the vehicle while the user is away.

2. Description of Related Art

Traditional vehicle alarms function by sounding an alarm when an intrusion or disturbance occurs to a vehicle. Upon sounding the alarm property damage and theft may be deterred because the noise often scares or startles the perpetrator. Also the noise may alert nearby persons that a crime is occurring thereby leading to the capture of the thief before they are able to take off with the car. While the common alarms are useful for a distracting sound, many do not have the ability to capture the thief once they surpass the alarm sounding deterrent.

Some recent developments have been made to provide additional features to the common vehicle alarm system. For example, U.S. Pat. No. 6,211,907 by Robert Jeff Scaman et al. discloses a secure, vehicle mounted, surveillance system. The system includes a video surveillance camera and GPS capabilities to enable a user to visually monitor and track their vehicle. Another development is U.S. Patent Application No. 20090096870 by Edward Zheng which discloses a GPS with back up camera. The GPS is used in the conventional manner to navigate the vehicle, but it also includes a camera built in for surveillance purposes.

It would be beneficial in the art to provide a security system for a vehicle that includes additional features other than simply sound and video surveillance. It would also be desirable in the art to provide a security system that allows the user to visually monitor the vehicle remotely.

### SUMMARY OF THE INVENTION

In view of the foregoing disadvantages inherent in the prior art, the general purpose of the present invention is to provide an enhanced vehicle security system, configured to include all of the advantages of the prior art, and to overcome the drawbacks inherent therein.

Accordingly, an object of the present invention is to provide an enhanced vehicle security system that includes an alarm, a camera, and a GPS tracker to monitor a vehicle.

Another object of the present invention is to provide an enhanced vehicle security system that includes a handheld device to alert a user that something is happening to their vehicle when an alarm within the vehicle is triggered.

Yet another object of the present invention is to provide an enhanced vehicle security system that enables a user to view real time video of their vehicle.

To achieve the above objects, in an aspect of the present invention, an enhanced vehicle security system is described comprising a camera mounted within a cabin of a vehicle, where upon activation the camera begins recording; a GPS tracker equipped within the vehicle, where upon activation the GPS tracker monitors a global positioning of the vehicle; an alarm within the vehicle, where the alarm is triggered when the vehicle is tampered with, and where when the alarm is triggered the camera and the GPS tracker are activated; a signal sent from the alarm when the alarm is triggered; and a handheld device transported with a user, where the handheld device receives the signal from the alarm.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of an enhanced vehicle security system inside a vehicle cabin in accordance with an exemplary embodiment of the present invention; and

FIG. 1(A) depicts a handheld device in accordance with an exemplary embodiment of the present invention.

### DETAILED DESCRIPTION OF THE DRAWINGS

The present invention relates to an enhanced vehicle security system that mounts inside the vehicle cabin to prevent theft or damage to the vehicle while the user is away. The enhanced vehicle security system includes a camera, GPS tracker and an alarm which work together to monitor what is happening to the vehicle while a user is away. The camera may record the interior and exterior of the vehicle to identify thieves and monitor the occurrences around the vehicle. The GPS tracker may inform the user as to the whereabouts of the vehicle in case the thieves successfully drive away with the vehicle. The alarm activates both the camera and GPS tracker and alerts the user that something is happening to the vehicle. With the enhanced vehicle security system vehicle a stolen vehicle may be quickly found and returned to the user, with better identification of the perpetrators for prosecution purposes.

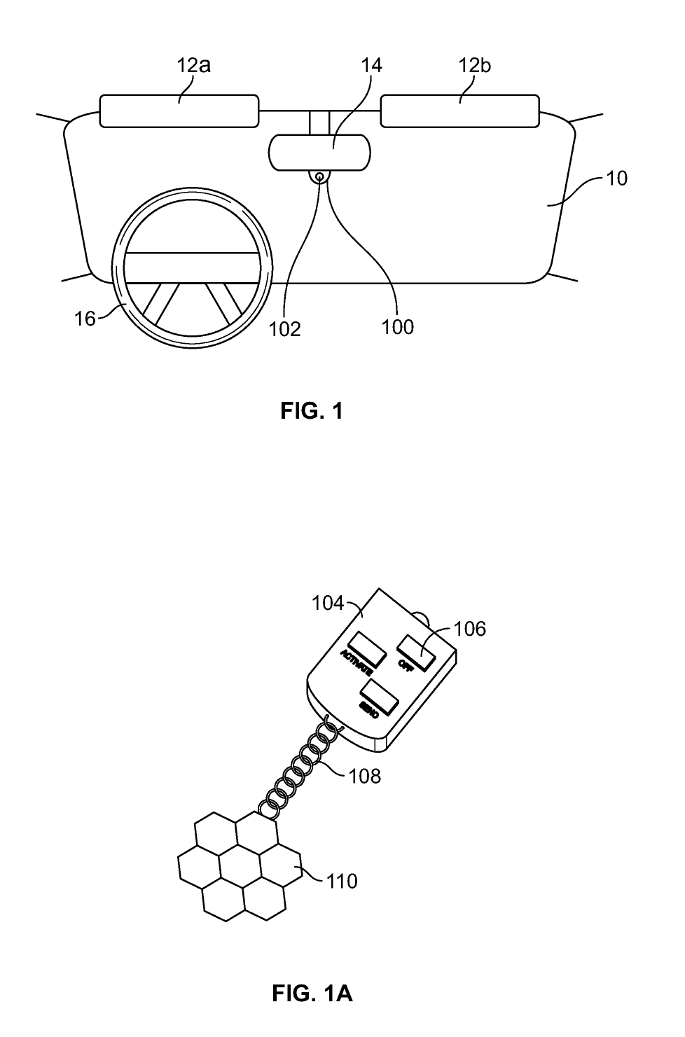

Turning now descriptively to the drawings, referring to FIG. 1, a perspective view of an enhanced vehicle monitoring system inside a vehicle cabin is shown in accordance with an exemplary embodiment of the present invention. Typically, the front portion of the vehicle cabin includes a windshield (10) that spans the entire front viewing area of the cabin. Along the upper edge of the windshield (10) are a pair of visors (12a, 12b), one in front of each front passenger. Attached to an upper portion of the windshield (10), between the visors (12a, 12b) is a rearview mirror (14) to enable the driver to view objects behind their vehicle. In front of the windshield (10) is a steering wheel (16) to enable the driver to steer the vehicle. Other objects commonly found in the cabin of the vehicle are a dashboard, glove compartment, seats, center console, gear shifter and the like. These objects are not shown for simplicity of illustration.

Mounted within the cabin is an enhanced vehicle security system. The enhanced vehicle security system includes a camera (100) that may be mounted to a front portion of the cabin. As illustrated in FIG. 1 the camera (100) is attached to the rearview mirror (14). Alternatively, the camera (100) may be attached to one of the visors (12a, 12b), the steering wheel (16), the dashboard or the windshield (10). The camera (100) includes a lens (102) that may rotate up and down and right to left to monitor the various areas of the cabin and the areas outside the vehicle that may be seen through the windshield (10), the passenger windows or the rear window.

Like many standard security systems, the enhanced vehicle security system may include an alarm secured with the vehicle that sounds a loud noise when the vehicle is tampered with. Once the alarm is triggered the camera (100) may turn on to start recording the activities within the vehicle cabin. The enhanced vehicle security system may include a GPS (Global Positioning System) tracker to monitor the location of the vehicle. When the alarm is triggered the GPS tracker is activated to monitor the global position of the vehicle.

Once the alarm is triggered the vehicle owner is alerted to inform them of what is happening in the vehicle. The alarm may send a signal to the local police authorities to receive the GPS information of the vehicle thereby enabling the authorities to find the vehicle and capture the perpetrators. The alarm may also send a signal to a handheld device (104) which is carried or transported with the user as shown in FIG. 1A. The handheld device (104) may beep, vibrate or flash to alert the user that the enhanced vehicle security system was triggered. The handheld device (104) may also serve as a remote control to enable the user to control various functions of the system. The handheld device (104) may include a chain (108) and a key ring (110) for attachment of the handheld device (104) to the user or to a set of keys, a purse, backpack, briefcase or the like.

A set of buttons (106) may be attached to the handheld device (104) to operate the various functions. For example, the set of buttons (106) may include an on or activate button, an off or deactivate button and a send button. The on button may activate the enhanced vehicle security system so that when the vehicle is tampered with the alarm triggers. Additionally, the on button may activate the alarm turning on the camera (100) to start recording video. The off button may deactivate the enhanced vehicle security system in case the alarms or monitoring begins accidentally. The send button may send the recorded and GPS information to a processing center which in turn sends a link via email or text to the user. Once the user receives the link they may monitor their vehicle via a specialized website that shows the user real time video taken from the camera and where their vehicle is located using the GPS tracker.

By utilizing the enhanced vehicle security system the user is better protected from vehicle theft. If such a crime occurs the user and local authorities may more quickly track the vehicle and identify the thieves than when using the standard vehicle alarm. The enhanced vehicle security system is also beneficial because the camera may record not only theft but also damage that may occur. Finally, the handheld device with the enhanced vehicle security system has an added benefit of self activation by the user in case of emergencies to allow them to record and then playback what is happening if necessary.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A enhanced vehicle security system comprising:
a camera mounted within a cabin of a vehicle, where upon activation the camera begins recording;
a GPS tracker equipped within the vehicle, where upon activation the GPS tracker monitors a global positioning of the vehicle;
an alarm within the vehicle, where the alarm is triggered when the vehicle is tampered with, and where when the alarm is triggered the camera and the GPS tracker are activated;
a signal sent from the alarm when the alarm is triggered; and
a handheld device transported with a user, where the handheld device receives the signal from the alarm.

2. The enhanced vehicle security system according to claim 1, wherein the handheld device includes a set of buttons to activate and deactivate the alarm.

3. The enhanced vehicle security system according to claim 2, wherein the set of buttons includes a send button to send the camera and GPS information to the user.

4. The enhanced vehicle security system according to claim 3, wherein the information is monitored remotely by the user via a specialized website.

5. The enhanced vehicle security system according to claim 1, wherein the handheld device includes a chain and a key ring.

6. The enhanced vehicle security system according to claim 5, wherein the key ring enables the handheld device to attach to the user.

7. The enhanced vehicle security system according to claim 1, wherein the handheld device performs one of at least beeps, vibrates and flashes when the alarm is triggered.

8. The enhanced vehicle security system according to claim 1, wherein the camera is mounted one of at least a rearview mirror, a visor, a steering wheel and a windshield within the cabin of the vehicle.
